(19) United States
(12) Patent Application Publication
(10) Pub. No.: US 2009/0226289 A1
(43) Pub. Date: Sep. 10, 2009

(54) LOADING AID AND TELESCOPIC CONVEYING DEVICE FOR GOODS TO BE CONVEYED, IN PARTICULAR FOR PIECE GOODS, HAVING THE FORMER

(75) Inventors: Sebastian Rittberg, Bremen (DE); Wolfgang Echelmeyer, Osterholz-Scharmbeck (DE); Hermann Franck, Ritterhude (DE); Matthias Miesbauer, Meppen (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/302,664

(22) PCT Filed: Mar. 16, 2007
(86) PCT No.: PCT/DE2007/000479

§ 371 Date: May 19, 2009

(30) Foreign Application Priority Data
Jun. 1, 2006 (DE) 10 2006 025 640.9

(51) Int. Cl. B65G 67/00

(52) U.S. Cl. 414/398; 414/809

(57) ABSTRACT

There is provided a loading aid for facilitating loading and unloading of a container. An exemplary loading aid comprises a working platform that is adapted to be moved on at least three rollers, at least one of which is steerable. The exemplary loading aid further comprises an autonomous steering device that is adapted to steer the at least one steerable roller, to autonomously steer the working platform straight ahead to avoid touching a wall of the container and to autonomously steer the working platform away from the wall of the container until the working platform is aligned parallel to the wall of the container if the working platform touches the wall of the container.

### CROSS REFERENCE TO RELATED APPLICATIONS

Pursuant to 35 U.S.C. § 371, this application is the United States National Stage Application of International Patent Application No. PCT/DE2007/000479, filed on Mar. 16, 2007, the contents of which are incorporated by reference as if set forth in their entirety herein, which claims priority to German (DE) Patent Application No. 10 2006 025 640.9, filed Jun. 1, 2006, the contents of which are incorporated by reference as if set forth in their entirety herein.

### BACKGROUND

According to the current state of the art, in order to unload piece goods from containers, a conveyer belt is telescoped into the container. Piece goods can be placed onto the conveyor belt and transported out of the container for purposes of further processing.

There are approaches in which a loading aid in the form of a working platform uses its drive to pull a conveyor belt into a container and is intended to carry persons as well as machines for unloading.

A drawback of this solution is the driven working platform that requires a special, non-driven conveyor belt. Since the majority of operations that unload piece goods use conveyor belts that have their own drive, this solution is not practicable.

Another problem lies in the fact that when the working platform, which runs on rollers, is moved backwards out of a container, it has a tendency to move away from its trajectory and in the direction of one wall of the container (like a trailer behind a car when it is being backed up).

The forces generated there have to be completely absorbed by the mechanism of the conveyor belt. The problem is considerably exacerbated when the container was parked at the loading dock at an incorrect angle.

Moreover, the problem exists of unloading piece goods from areas at the very bottom or at the very top of the container, since the height of the working platform cannot be dynamically adjusted. If the working platform is set up too high, then unloading the piece goods from the bottom of the container is very uncomfortable and ergonomically unacceptable. The same problem occurs if the working platform is too low and piece goods are to be unloaded from the top of the container.

It is often the case that, whenever the conveyor belts are not needed, they are pushed away from the loading dock and parked parallel to one side of the warehouse. Otherwise, they would unnecessarily occupy valuable warehouse space. Parking the conveyor belts parallel in this way is not possible with the existing solutions.

### SUMMARY OF THE INVENTION

An exemplary embodiment of the present invention relates to a loading aid in the form of a working platform that can be moved on at least three rollers, at least one of which can be steered, for loading and unloading containers, as well as to a telescopic conveying device for goods to be conveyed, in particular for piece goods, having a telescope-like conveying means for transporting the goods to be conveyed.

An exemplary embodiment of the present invention may desirably eliminate, or at least reduce, the above-mentioned problems.

According to an exemplary embodiment of the present invention, this objective may be achieved with the loading aid of the type described above in that an autonomous mechanical steering device is provided for steering the at least one steerable roller, wherein the working platform is autonomously steered straight ahead without touching a wall of the container and, if it touches a wall of the container, it is autonomously steered away from the wall until the working platform is aligned parallel to the wall of the container.

According to an exemplary embodiment of the present invention, it can be provided that the steering device has at least one mechanical contact detector on each side of the working platform for detecting contact with a wall of the container in the entry direction.

Advantageously, the contact detector may be configured in such a way that, when it detects contact with a wall of the container, it mechanically steers the working platform away from the wall of the container by changing the direction of travel until the working platform is aligned parallel to the wall of the container.

In one exemplary embodiment of the present invention, it may be advantageous for the contact detector to be mechanically connected to the steering axle of a steerable roller.

According to another exemplary embodiment of the present invention, it can be provided that the working platform has one single steerable roller, the steering device has exactly one mechanical contact detector on each side of the working platform for detecting contact with a wall of the container in the entry direction, and each contact detector is mechanically connected to the steering axle of the single steerable roller.

On the other hand, it can also be provided that the working platform has two steerable rollers that are arranged in the entry direction next to each other at a distance from each other, and the steering axles of said rollers are each mechanically connected to an appertaining contact detector. For example, the working platform can have four rollers that are arranged in a rectangular or square formation, and the two rollers that are in the front as seen in the entry direction can be steered by means of the autonomous steering device. In one exemplary embodiment of the present invention, all four rollers are steerable. In an exemplary embodiment of the present invention, the contact detector comprises a runner-like guide rail that extends essentially horizontally and that has ends bent towards the working platform, said ends being connected to the steering axle of each associated steerable roller via a horizontally extending fastening device.

In particular, it can be provided that the guide rail is provided with at least one roller. This can be beneficial in order to avoid damage to a wall of the container and/or in order to make it run more smoothly.

According to another exemplary embodiment of the present invention, the fastening device comprises at least one rod or pipe.

Advantageously, the rod or the pipe can be moved linearly. Linear mobility may be needed in order to drive through narrow loading docks and this can allow a reduction in the width of the entire system. The linear mobility can be achieved by hydraulic cylinders, perforated rods, clamping bars, etc. When hydraulic cylinders are used, the linear movement can be carried out automatically.

Advantageously, the one or the at least one steerable roller can be autonomously steered by a spring straight ahead to avoid contact with a wall of the container.

As an alternative, it is also conceivable that the one or the at least one steerable roller can be autonomously steered by a pressurized gas cylinder straight ahead to avoid contact with a wall of the container. It is also possible to use rubber straps, etc. between the unmovable part of the loading aid and the movable elements of the steering device.

Advantageously, the height of the working platform may be adjustable.

In particular, it can be provided that the height of the working platform is adjustable by a scissor lift.

Advantageously, at least one foot switch may be provided on the working platform.

Finally, according to another exemplary embodiment of the present invention, it can be provided that the loading aid has its own drive.

Furthermore, an exemplary embodiment of the present invention may provide a telescopic conveying device for goods to be conveyed, especially for piece goods, having a telescope-like conveying device for transporting the goods to be conveyed and having an associated loading aid.

Advantageously, the loading aid may be connected to the conveying device via a coupler. The coupler can be detachable or non-detachable.

According to another exemplary embodiment of the present invention, the conveying device may be a telescopic conveyor belt.

According to an exemplary embodiment of the present invention, rather than having a drive of its own, the loading aid can be driven by the telescopic conveyor belt.

According to an exemplary embodiment of the present invention, the loading aid can be moved by the coupler out of a working position—in which the working platform is arranged movably on one end of the telescopic conveyor belt at the front in the entry direction—into a stowed position—in which the working platform is situated underneath the front end of the telescopic conveyor belt. In this manner, the loading aid can be moved together with the telescopic conveyor belt.

Finally, it can be advantageously provided that the working platform may not touch the floor when it is in the stowed position.

In one exemplary embodiment of the present invention, the autonomous mechanical steering device makes possible an autonomous steering without the use of complicated scanning and control electronics.

### BRIEF DESCRIPTION OF THE DRAWINGS

Additional features and advantages of the invention can be gleaned from the description below in which exemplary embodiments of the present invention are explained in detail with reference to the schematic drawings, in which the following is shown:

FIG. 1 is a schematic side view of a telescopic conveying device with a loading aid according to an exemplary embodiment of the invention in the working position;

FIG. 2 is a schematic side view of the telescopic conveying device of FIG. 1 with a loading aid in the stowed position;

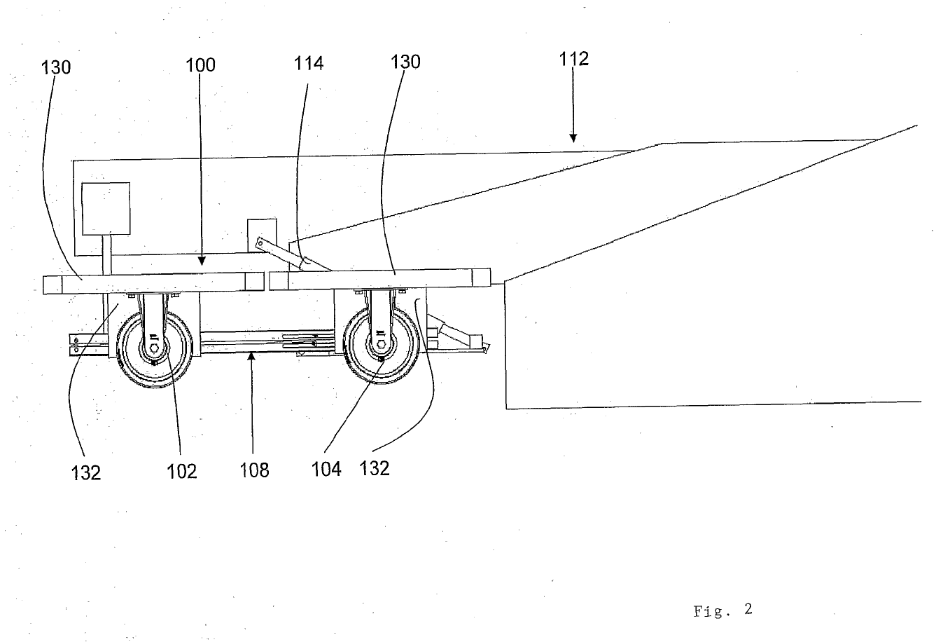

FIG. 3 is a perspective view of the telescopic conveying device of FIG. 1;

FIG. 4 is a top view of the telescopic conveying device of FIG. 1 while it is entering a container;

FIG. 5 is a top view of the telescopic conveying device of FIG. 1 while it is entering the container, at a later stage;

FIG. 6 is a front view of a steerable roller;

FIG. 7 is a schematic diagram of a hydraulic coupling system in accordance with an exemplary embodiment of the present invention;

FIG. 8 is a schematic diagram showing a first stage of a the stowing sequence for the loading aid in simplified form in accordance with an exemplary embodiment of the present invention;

FIG. 9 is a schematic diagram showing a second stage of a stowing sequence for the loading aid in simplified form in accordance with an exemplary embodiment of the present invention;

FIG. 10 is a schematic diagram showing a third stage of a stowing sequence for the loading aid in simplified form in accordance with an exemplary embodiment of the present invention;

FIG. 11 is a schematic diagram showing a fourth stage of a stowing sequence for the loading aid in simplified form in accordance with an exemplary embodiment of the present invention; and

FIG. 12 is a schematic diagram showing a fifth stage of a stowing sequence for the loading aid in simplified form in accordance with an exemplary embodiment of the present invention.

### DETAILED DESCRIPTION OF SPECIFIC EMBODIMENTS

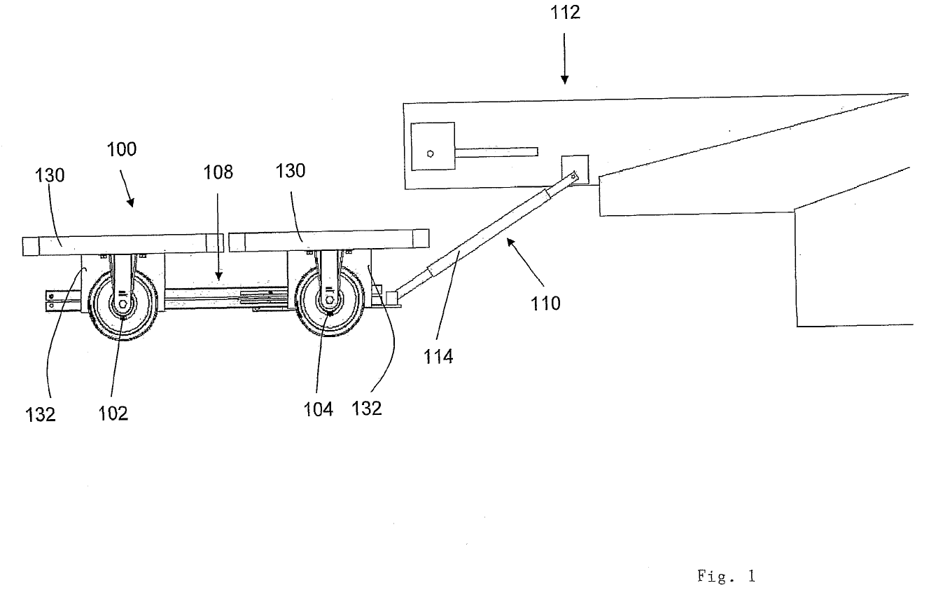

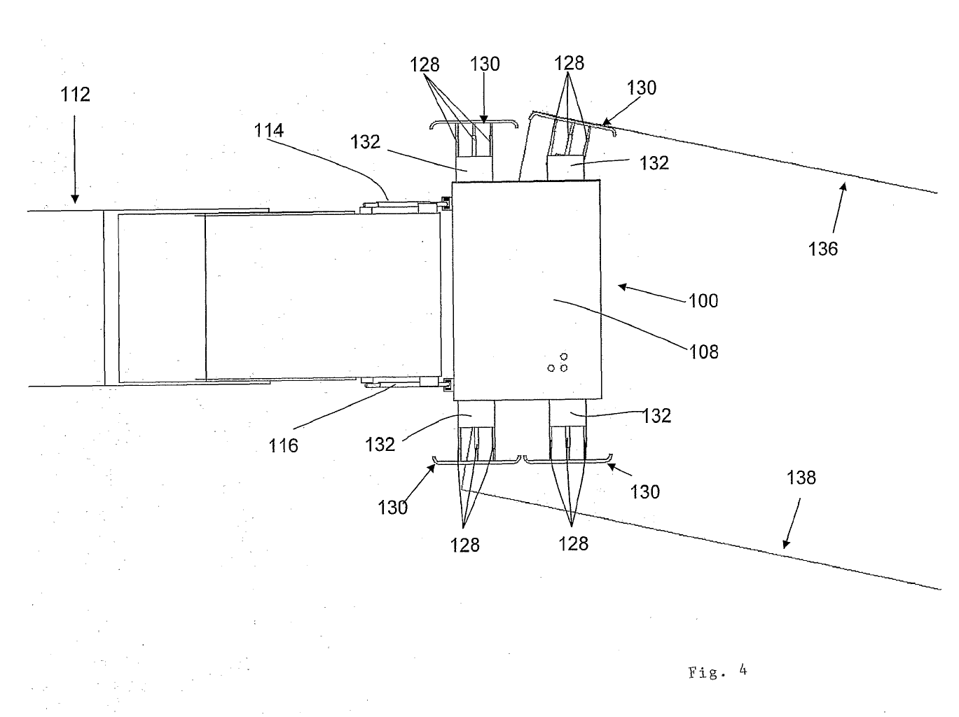

In an exemplary embodiment of the present invention, the loading aid 100 shown in FIG. 1 has a rectangular working platform 108 that can be moved on four steerable rollers—only two of which with the reference numerals 102 and 104 are visible here—and that is intended for loading and unloading containers. The steerable rollers are arranged in a rectangular formation around the working platform 108. The working platform 108 is connected by a coupler 110 to the front end of a telescopic conveyor belt 112. The coupler 110 may consist of two hydraulic cylinders 114 and 116 (see FIG. 4). Via these hydraulic cylinders 114 and 116, the left side of the telescopic conveyor belt 112 is connected to the left side of the working platform 108 and the right side of the telescopic conveyor belt 112 is connected to the right side of the working platform 108. The hydraulic cylinders 114 and 116 are preferably connected via coupling balls (without reference numerals) to the working platform 108 and to the telescopic conveyor belt 112, since this allows mobility in the horizontal and vertical directions.

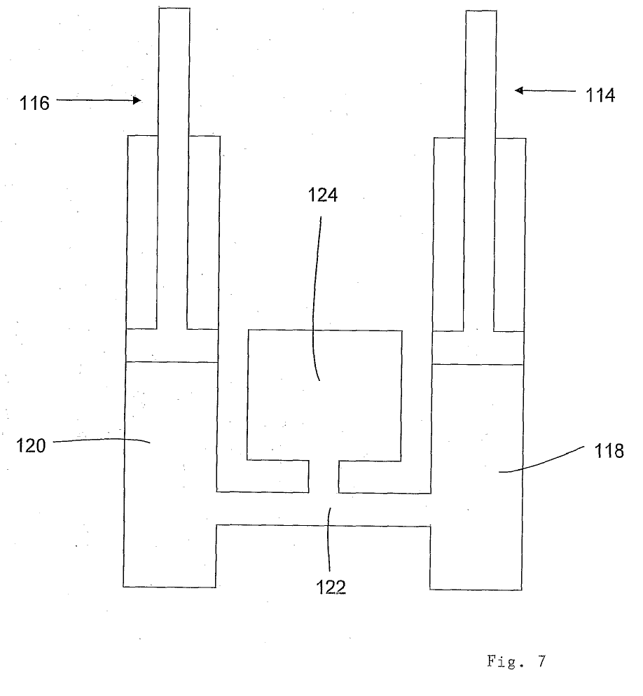

In the exemplary embodiment of the present invention shown in FIG. 1, chambers 118 and 120 of the hydraulic cylinders 114 and 116 are connected to each other hydraulically via a connection 122 (see FIG. 7).

In case of a uniform load (when moving straight ahead), the hydraulic cylinders 114 and 116 are uniformly extended. During a steering maneuver, the forces that act on the hydraulic cylinders 114 and 116 differ from each other. For example, during a steering maneuver to the left, the pressure on the left-hand hydraulic cylinder 114 increases, so that it is compressed. As a result, hydraulic oil flows from the left hydraulic cylinder 114 via the connection 122 into the right-hand hydraulic cylinder 116. This, in turn, brings about an equal force transmission between the telescopic conveyor belt 112 and the working platform 108 when in the positioned state.

The hydraulic cylinders 114 and 116 serve to transmit the forces for the forward and backward movement of the telescopic conveyor belt 112 to the working platform 108. By the same token, a change in the orientation can be made between the stationary telescopic conveyor belt 112 and the steered working platform 108.

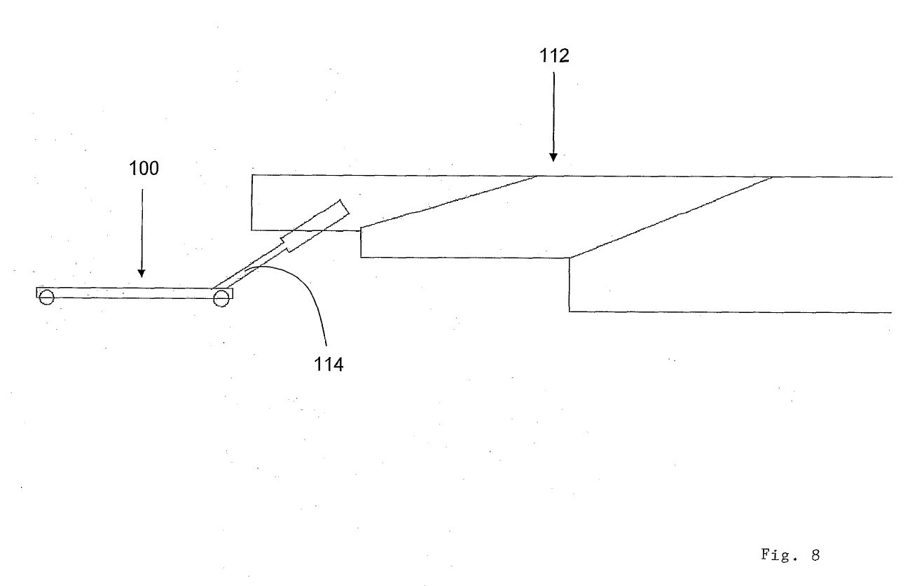

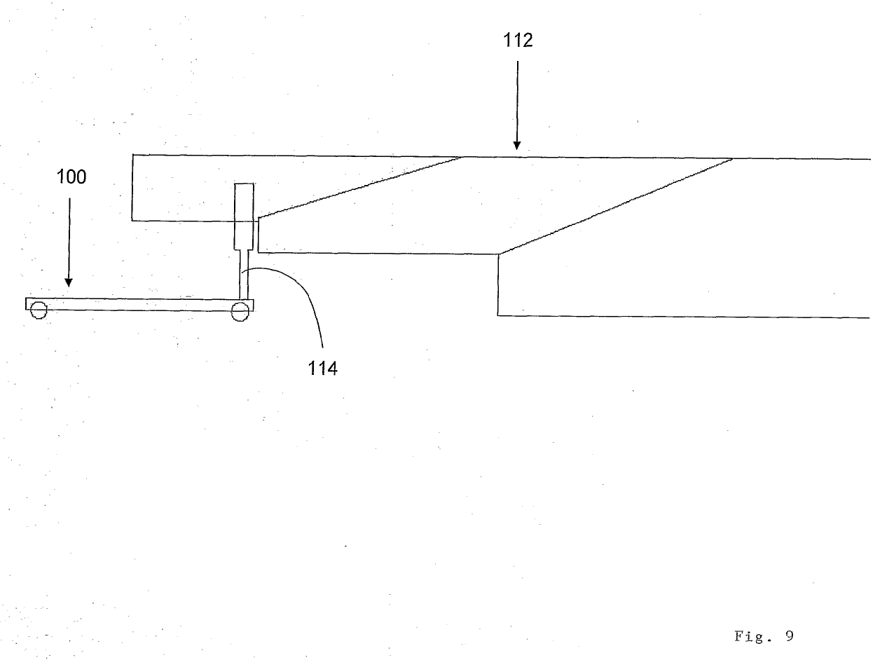

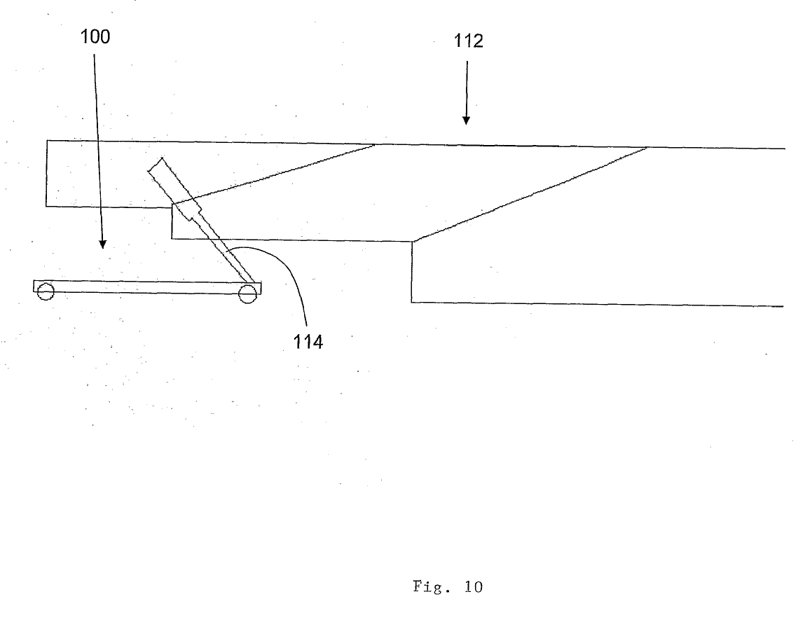

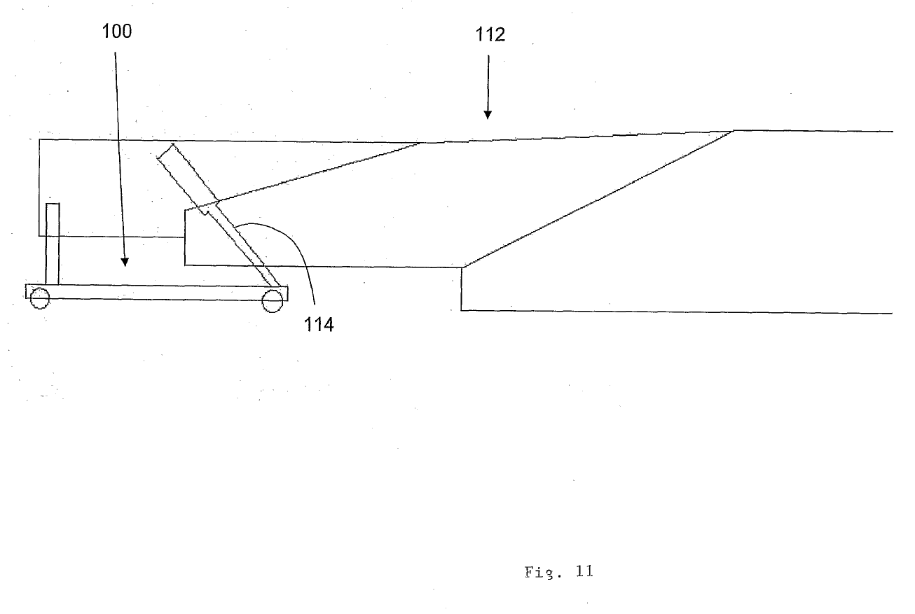

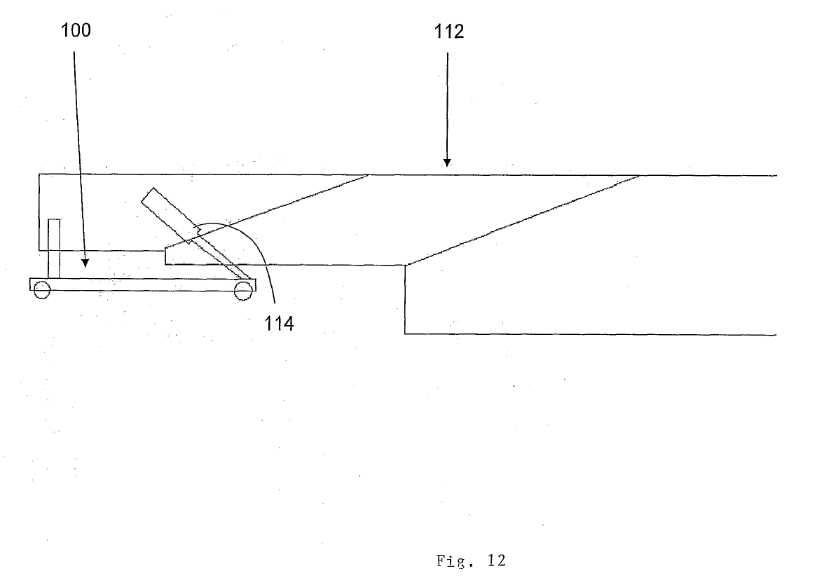

In order to stow the telescopic conveyor belt 112 and in order to stow the loading aid 100 (see FIGS. 8 to 12), the hydraulic cylinders 114 and 116 are shortened. For this purpose, hydraulic oil is drained out of the hydraulic cylinders 114 and 116 into a compensation tank 124. In principle, the position of the compensation tank can be freely selected since it only has to be connected by thin hydraulic lines such as a pipe or a hose. An advantageous position may be, for example, near the hydraulic supply of the loading aid. Instead of a compensation tank, it is also possible to provide a pump to drain hydraulic oil from the hydraulic cylinders 114 and 116. As a result, the working platform 108 is pulled or pushed under the telescopic conveyor belt 112. The hydraulic cylinders 114 and 116 are now in a perpendicular position between the upper edge of the working platform 108 and the lower edge of the telescopic conveyor belt 112 (see FIG. 9). The working platform 108 is now retracted further; the hydraulic cylinders 114 and 116 lengthen again and hydraulic oil flows out of the compensation tank back into the hydraulic cylinders 114 and 116 (see FIG. 10). As a result, the rear edge of the working platform 108 is located behind the front edge of the telescopic conveyor belt 112. Now, all of the hydraulic lines are closed. The hydraulic cylinders 114 and 116 are now rigid. The telescopic conveyor belt 112 is lowered and the working platform 108 retracts further to the back (see FIG. 11). Now the front of the working platform 108 is connected via a rod, a cable, etc. (not shown here) to the front of the telescopic conveyor belt 112 (see FIG. 11). The telescopic conveyor belt 112 can now be raised together with the working platform 108. The working platform 108 is lifted and is now suspended below the telescopic conveyor belt 112 (see FIG. 12). In order to move out of the stowed position back into the working position, the procedure is reversed. The stowing procedure can be controlled manually as well as automatically.

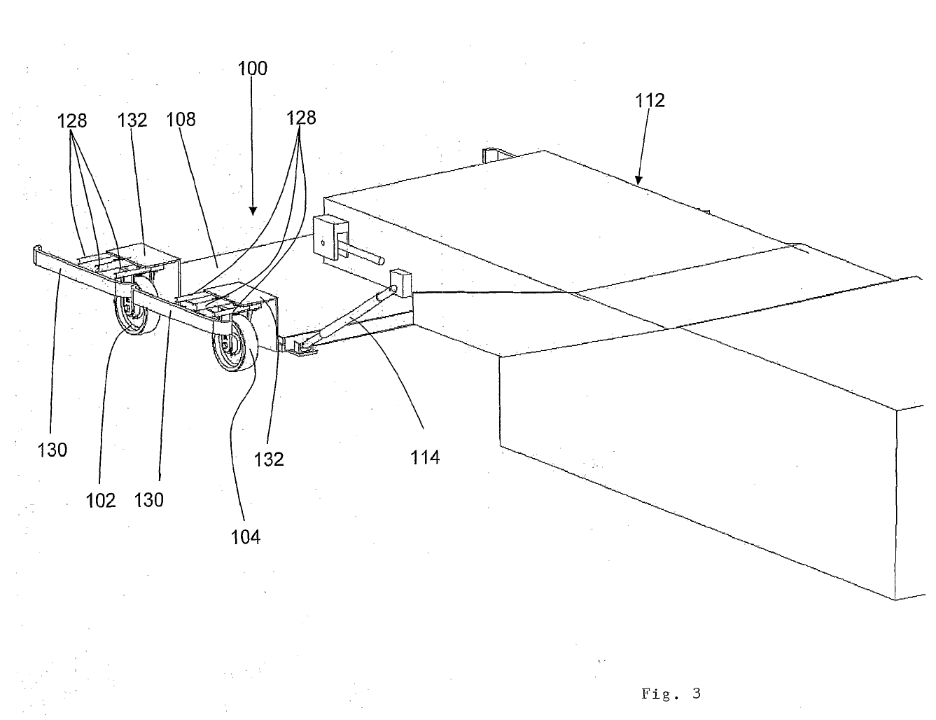

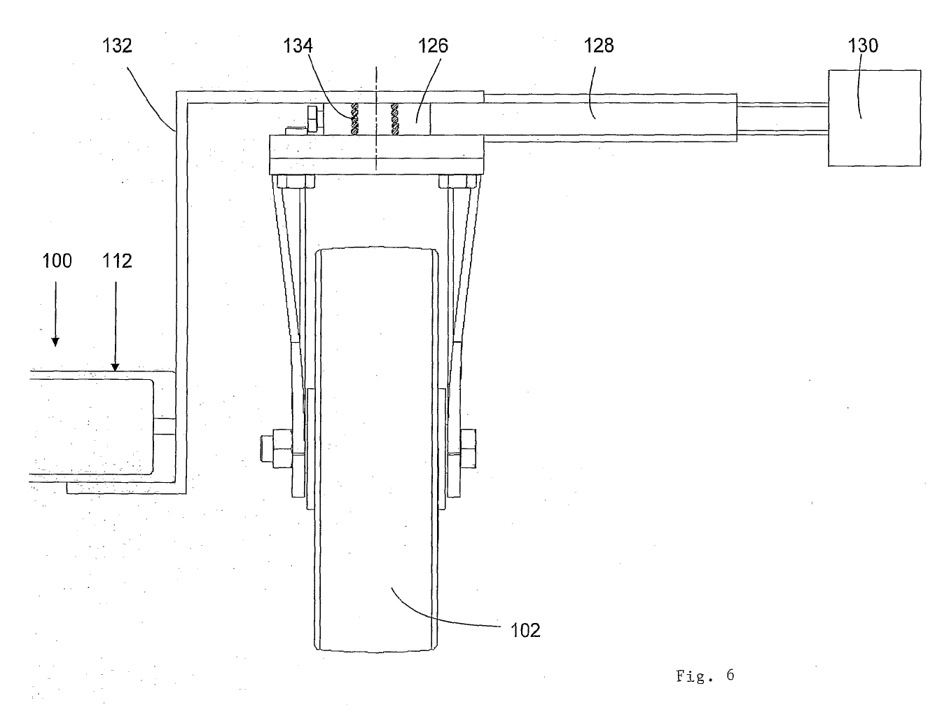

As can be seen in FIGS. 3 to 6, the steerable rollers 102 and 104 may be connected to their appertaining steering axles 126 via three hydraulic cylinders 128, each with an appertaining guide rail 130. In the present case, the steering axle 126 is connected to the working platform 108 via a holder 132. The holder 132 makes it possible to lower the working platform 108 further so as to minimize the height of the overall structure. However, the steering axle can also be above or below the working platform 108 or the holder 132 or else it can be an extension of the axle of a roller.

The steerable rollers 102 and 104 are autonomously steered using their own spring 134 straight ahead into a state where it does not make contact with a wall of the container. The spring 134 is a spiral spring that is coiled around the steering axle 126. As an alternative, it is also possible to use springs, pressurized gas cylinders, rubber straps, etc. between the non-movable part of the overall system (working platform 108, holder 132) and the movable elements of the steering system (guide rails, etc.).

The ends of the guide rails 130 may be bent inwards so that jamming against the wall of the container is not possible.

The procedure for driving the device into a container and driving it back out will be described below:

When the device enters a container having side walls 136 and 138, the hydraulic cylinders 128 and thus the guide rails 130 are extended so far that the left-hand guide rails 130 touch the left wall 136 of the container if the device is driven into the container at an angle. The guide rails 130 and the hydraulic cylinders 128 cause this contact to be converted into a change in the driving direction away from the left wall 136 of the container. The rollers 102 and 104 are guided by the guide rails 130 and the entire working platform 108 is aligned parallel to the wall 136 of the container. Now the device can be driven into the entire container without any problem.

If the guide rails 130 do not come into contact with the walls 136 and 138 of the container, the steerable rollers 102, 104 may be positioned by the springs 134 so that they can be driven straight ahead.

In one exemplary embodiment of the present invention, the height of the working platform 108 can be adjusted hydraulically. The flattest possible structure is desirable so that goods can be unloaded from the bottom area of a container. In the raised state, goods can be unloaded without any problem from a container that is loaded to the ceiling.

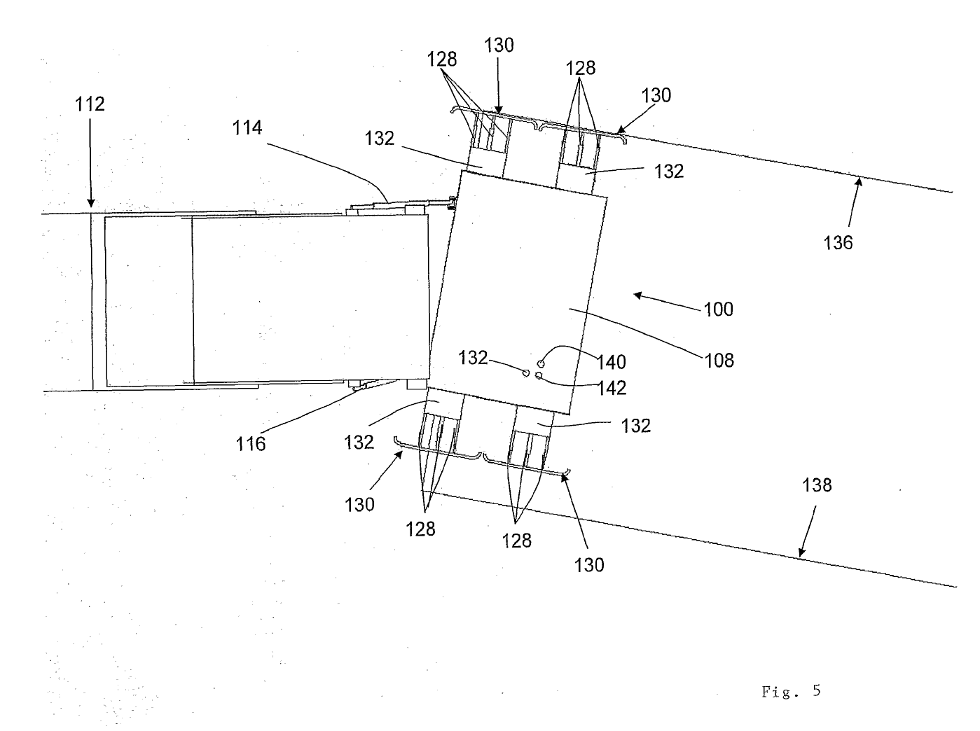

The height adjustment as well as the forward and backward movement can be carried out conveniently and safely by means of foot switches 140, 142 and 144 (see FIG. 5) located on the floor of the working platform 108. This makes it possible to carry out a complete loading or unloading procedure without having to leave the working platform 108.

According to an exemplary embodiment of the present invention, a loading aid is created that is autonomously steered, that is height-adjustable and that can be stowed under a telescopic conveying device, for example, a telescopic conveyor belt, by a special coupler. In this manner, the loading aid allows convenient unloading from all of the areas of a container. Moreover, when it is not in use, it can be moved away with the entire conveying means. The loading aid is driven passively, that is to say, that the loading aid may be moved using the drive of the existing conveying device.

The features of an exemplary embodiment of the present invention disclosed in the present description as well as in the drawings can be used either individually or in any desired combinations for the execution of the invention in its various exemplary embodiments.

1-21. (canceled)

22. A loading aid for facilitating loading and unloading of a container, the loading aid comprising:
a working platform that is adapted to be moved on at least three rollers, at least one of which is steerable; and
an autonomous steering device that is adapted to steer the at least one steerable roller, to autonomously steer the working platform straight ahead to avoid touching a wall of the container and to autonomously steer the working platform away from the wall of the container until the working platform is aligned parallel to the wall of the container if the working platform touches the wall of the container.

23. The loading aid recited in claim 22, wherein the steering device comprises at least one mechanical contact detector on each side of the working platform for detecting contact with a wall of the container.

24. The loading aid recited in claim 23, wherein the steering device is adapted to steer the working platform away from the wall of the container by changing the direction of travel until the working platform is aligned parallel to the wall of the container when the contact detector detects contact with a wall of the container.

25. The loading aid recited in claim 23, wherein the contact detector is mechanically connected to a steering axle of the at least one steerable roller.

26. The loading aid recited in claim 22, wherein the working platform has only one single steerable roller, and wherein the steering device has exactly one mechanical contact detector on each side of the working platform for detecting contact with a wall of the container, and wherein each contact detector is mechanically connected to a steering axle of the single steerable roller.

27. The loading aid recited in claim 22, wherein the working platform has two steerable rollers that are arranged in an entry direction next to each other at a distance from each other, and the steering axles of the steerable rollers are each mechanically connected to an appertaining contact detector.

28. The loading aid recited in claim 22, wherein the steering device comprises at least one mechanical contact detector on each side of the working platform for detecting contact with a wall of the container, each contact detector comprising a runner-like guide rail that extends essentially horizontally and that has ends bent towards the working platform, the ends being connected to a steering axle of each steerable roller via a horizontally extending fastening device.

29. The loading aid recited in claim 28, wherein the guide rail comprises at least one roller.

30. The loading aid recited in claim 28, wherein the fastening device comprises at least one rod or pipe.

31. The loading aid recited in claim 30, wherein the rod or the pipe is adapted to be moved linearly.

32. The loading aid recited in claim 22, wherein the steering device is adapted to autonomously steer the at least one steerable roller straight ahead to avoid contact with a wall of the container using a spring.

33. The loading aid recited in claim 22, wherein the steering device is adapted to autonomously steer the at least one steerable roller straight ahead to avoid contact with a wall of the container using a pressurized gas cylinder.

34. The loading aid recited in claim 22, wherein a height of the working platform is adjustable.

35. The loading aid recited in claim 22, comprising a scissor lift that is adapted to adjust a height of the working platform.

36. The loading aid recited in claim 22, comprising at least one foot switch on the working platform.

37. The loading aid recited in claim 22, comprising a drive device that is adapted to drive the loading aid.

38. A system for loading and unloading a container, the system comprising:
a loading aid, comprising:
a working platform that is adapted to be moved on at least three rollers, at least one of which is steerable; and
an autonomous steering device that is adapted to steer the at least one steerable roller, to autonomously steer the working platform straight ahead to avoid touching a wall of the container and to autonomously steer the working platform away from the wall of the container until the working platform is aligned parallel to the wall of the container if the working platform touches the wall of the container; and
a telescopic conveying device associated with the loading aid, the telescopic conveying device having a telescope-like conveyer for transporting goods to be conveyed.

39. The system for loading and unloading a container recited in claim 38, wherein the loading aid is connected to the telescope-like conveyer via a coupler.

40. The system for loading and unloading a container recited in claim 38, wherein the telescope-like conveyer comprises a telescopic conveyor belt.

41. The system for loading and unloading a container recited in claim 38, wherein the loading aid is adapted to be moved via a coupler out of a working position—in which the working platform is arranged movably on one end of the telescope-like conveyer at the front in an entry direction—into a stowed position—in which the working platform is situated underneath a front end of the telescope-like conveyer.

42. The system for loading and unloading a container recited in claim 41, wherein the working platform does not touch the floor when it is in the stowed position.

43. A method of operating a loading aid that facilitates loading and unloading of a container, the method comprising:
moving a working platform on at least three rollers, at least one of which is steerable;
autonomously steering the at least one steerable roller so that the working platform moves straight ahead to avoid touching a wall of the container; and
autonomously steering the at least one steerable roller so that the working platform moves away from the wall of the container until the working platform is aligned parallel to the wall of the container if the working platform touches the wall of the container.
